(19) United States
(12) Patent Application Publication
(10) Pub. No.: US 2025/0171654 A1
(43) Pub. Date: May 29, 2025

(54) STORAGE STABLE, ONE-COMPONENT, SOLVENT-FREE, NON-HALOGENATED, HEAT CURABLE COMPOSITIONS FOR USE IN ENCAPSULATION OF ELECTRICAL COMPONENTS

(71) Applicants: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(72) Inventors: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(21) Appl. No.: 18/522,629

(22) Filed: Nov. 29, 2023

(51) Int. Cl. C09D 163/00; C09D 5/18; C09D 7/48; C09D 7/61; C09D 7/63; C09D 7/65

(52) U.S. Cl. CPC C09D 163/00; C09D 5/18; C09D 7/48; C09D 7/61; C09D 7/63; C09D 7/65

(57) ABSTRACT

A storage stable, one-component, solvent-free, non-halogenated, heat curable composition which cures to form a cured product for use in encapsulation of electrical components, including: (a) an epoxy resin; (b) a non-halogenated flame retardant based on phosphorus containing epoxy resin; (c) a cyclic anhydride hardening agent; (d) a catalyst; (e) a rheology modifier; (f) a heat stabilizing agent; and (g) wherein the composition is fast gelling/curing and exhibits a high glass transition temperature, and excellent mechanical, electrical, and flame-retardant properties.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to compositions used in the encapsulation of electric motors, generators, transformers, power supplies, and associated components (e.g., insulators, stators, rotors, switchgears, bushings, housings, printed circuit boards, etcetera), and, more particularly, to long-term storage stable, one-component, solvent-free, non-halogenated, heat curable compositions that are used in the encapsulation of electrical components.

The heat curable compositions of the present invention provide for cured products that, among other things, are: (1) fast gelling/curing, (2) exhibit a high glass transition temperature (i.e., T_{g}); (3) exhibit excellent mechanical properties (e.g., flexural strength, tensile strength, tensile modulus, shear strength, etcetera); (4) exhibit excellent electrical properties for motor coil/stator/rotor insulation (e.g., volume resistance, dielectric constant, dissipation factor, break down voltage, etcetera); and (5) exhibit excellent flame retardant properties in accordance with UL94 standard.

### 2. Background Art

Electric motors, rotors, and stators, as well as encapsulation materials for these electrical components have been known in the art for years and are the subject of a plurality of patents and publications, including: U.S. Pat. No. 9,960,646 entitled “Fixing Resin Composition for Use in Rotor,” U.S. Pat. No. 9,634,533 entitled “Motor with a Stator Having Four Separate Corner Bobbins/Insulators and Molded Resin Insulation around Tooth Completely Enclosing the Coil and Manufacturing Method Thereof,” U.S. Pat. No. 8,922,076 entitled “Encapsulated Stator,” U.S. Pat. No. 8,541,532 entitled “Silane Compound, Production Method Thereof, and Resin Composition Containing Silane Compound,” U.S. Pat. No. 7,023,098 entitled “Resin Composition for Encapsulating Semiconductor Chip and Semiconductor Device Therewith,” U.S. Pat. No. 5,726,391 entitled “Thermosetting Encapsulants for Electronics Packaging,” U.S. Pat. No. 5,189,081 entitled “Penetrable, Epoxy Resin Composition Comprising Glycidyl Ether of Bisphenol Modified with Glycol or Urethane, and Inorganic Filler,” U.S. Pat. No. 4,695,598 entitled “Epoxy Resin Coating Composition,” United States Patent Application Publication Number 2015/0130318 entitled “Resin Composition for Rotor Fixing, Rotor, and Automotive Vehicle,” and Chinese Patent Number 1286906 entitled “Epoxy Resin Composition and Semiconductor Device”—all of which are hereby incorporated herein by reference in their entirety including all references cited therein.

U.S. Pat. No. 9,960,646 appears to disclose a resin composition for use in a rotor that includes a thermosetting resin containing an epoxy resin, a curing agent, and an inorganic filler, wherein the content of the inorganic filler is equal to or more than 50% by mass, based on 100% by mass of the total content of the fixing resin composition.

U.S. Pat. No. 9,634,533 appears to disclose a stationary portion of a motor that includes resin bodies including an inner resin portion and an outer resin portion. The inner resin portion is between a tooth and a coil and between the tooth and an insulator. The outer resin portion covers circumferentially outer sides and axially outer sides of the coil. The inner and outer resin portions are continuous with each other through a connecting resin portion. The insulator includes an opening portion extending along circumferential side surfaces of the tooth. The inner resin portion is in contact with the circumferential side surfaces of the tooth and a conducting wire in the opening portion. Heat generated in the coil is transferred to the tooth through the resin body. A path along which the heat is transferred from the coil to the tooth is secured, and dissipation of heat out of the motor is promoted.

U.S. Pat. No. 8,922,076 appears to disclose an encapsulated stator that includes a driving module coupled to a shaft tube. The driving module includes a silicon steel plate unit. A coil unit is wound around the silicon steel plate unit. A jacket is mounted to an outer periphery of the silicon steel plate unit of the driving module. The jacket includes an inner face and an outer face opposite to the inner face. The inner face of the jacket faces the driving module. An encapsulant is bonded to the driving module, the jacket, and the shaft tube. The encapsulant encapsulates the driving module. The encapsulant also partially encapsulates the outer face of the jacket.

U.S. Pat. No. 8,541,532 appears to disclose a siloxane compound that includes a structure unit formed by connecting at least one organic skeleton having an imido bond to a silicon atom forming a siloxane bond, wherein the silane compound is defined by the following average formula: XaYbZcSiOd. X denotes groups including an organic skeleton having an imido bond, represented by formula (1) in the specification; Z denotes organic groups having no imido bond; Y denotes at least one of hydrogen, hydroxyl, halogen, and OR; R denotes at least one of alkyl, acyl, aryl, and unsaturated aliphatic residual groups and may have a substituent; a is ≤3 and >0; b is 0≤3; c is 0≤3; d is ≤2 and >0; and a+b+c+2d=4, R¹ denotes at least one from aromatic, heterocyclic, and alicyclic rings; x and z independently ≥0 and ≤5; and y is 0 or 1.

U.S. Pat. No. 7,023,098 appears to disclose an epoxy resin composition for encapsulating a semiconductor chip, which has good flowability without deterioration in curability. Specifically, the resin composition for encapsulating a semiconductor chip contains an epoxy resin (A), a phenol resin (B), an inorganic filler (C) and a curing accelerator (D) as main components, and further contains a silane coupling agent (E) in 0.01 wt. % to 1 wt. % both inclusive of the total amount of the epoxy resin composition and compound (F) contains two hydroxyl groups combined with each of adjacent carbon atoms in an aromatic ring in more than or equal to 0.01 wt. % of the total amount of the epoxy resin composition.

U.S. Pat. No. 5,726,391 appears to disclose an electronic package where in a semiconductor device on a substrate is encapsulated with a thermally reworkable encapsulant composition including: (a) a thermally reworkable crosslinked resin produced by reacting at least one dienophile having a functionality greater than one and at least one 2,5-dialkyl substituted furan-containing polymer, and (b) at least one filler present from about 25 to about 75 percent by weight based upon the amount of components (a) and (b). Such a process provides a readily reworkable electronic package.

U.S. Pat. No. 5,189,081 appears to disclose a penetrable, epoxy resin composition which includes: a liquid, epoxy resin mixture containing a glycidyl ether of bisphenol having an epoxy equivalent of 158-270 and a flexible epoxy resin; a curing agent capable of reacting with the epoxy resin mixture when heated to a curing temperature; an inert organic solvent which does not react with the epoxy resin mixture, which is capable of dissolving the curing agent and which has a boiling point lower than the curing temperature; and an inorganic filler having an average particle size of 0.1-5 μm.

U.S. Pat. No. 4,695,598 appears to disclose an epoxy resin coating composition including a rubber-modified epoxy resin which is obtained by reacting an epoxy resin with a carboxyl group-containing butadiene-acrylonitrile rubber, a phenoxy resin, a metal powder, a curing component, and an organic solvent. This composition is especially useful as a coating for fuel tanks. The cured coating from the composition has reported properties of heat resistance, chemical resistance, corrosion resistance, flexibility and weldability.

United States Patent Application Publication Number 2015/0130318 appears to disclose a rotor-fixing resin composition including: an epoxy resin-containing thermosetting resin; a curing agent; and an inorganic filler, wherein a tensile elongation at break-a is 0.1% or higher and 1.7% or lower, the tensile elongation at break-a is obtained by subjecting a test piece to a tensile test pursuant to JIS K7162 under conditions of a temperature of 120° C., a test force of 20 MPa and 100 hours, and the test piece is a cured product produced by subjecting the rotor-fixing resin composition to curing by heating at 175° C. for 4 hours, and molding to a dumbbell shape pursuant to JIS K7162.

Chinese Patent Number 1286906 appears to disclose an epoxy resin composition with the advantages of favorable formability and fire resistance, low water absorption ratio and favorable soldering tin resistance. The epoxy resin composition used for sealing semiconductors contains epoxy resin of which the content of aromatic carbon atoms is more than 70%, phenolic resin of which the content of aromatic carbon atoms is more than 70% and the equivalence of phenolic hydroxyls is from 140 to 300, curing accelerators and inorganic filling material with 88<=W (addition weight)<=94 (weight %). In the analysis of a TG curved line of the solidified epoxy resin composition in the air atmosphere, the starting temperature of combustion is more than 280° C., and the survival rate A (weight %) of solidified substances satisfies the formula of W+[0.1*(100−W)]<=A.

While the above-identified patents and publications do appear to disclose various electrical components and encapsulation materials for these electrical components, their formulations remain non-desirous and/or problematic inasmuch as, among other things, none of the above-identified compositions are long-term storage stable, one-component, solvent-free, non-halogenated, heat curable compositions that among other things, are fast gelling/curing, exhibit a high glass transition temperature, and exhibit excellent electrical, mechanical and flame retardant properties.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a storage stable, one-component, solvent-free, non-halogenated, heat curable composition which cures to form a cured product for use in encapsulation of electrical components, comprising, consisting essentially of, and/or consisting of: (a) one or more epoxy resins; (b) one or more non-halogenated flame retardants based on a phosphorus containing epoxy resin; (c) one or more cyclic anhydride hardening agents; (d) one or more catalysts; (e) one or more rheology modifiers; (f) one or more heat stabilizing agents; and wherein the composition is fast gelling/curing and exhibits a high glass transition temperature, and excellent mechanical, electrical, and flame-retardant properties. The present invention is also directed to cured products formed using the compositions disclosed herein.

In a preferred embodiment of the present invention, the curable composition cures at a temperature of at least 140° C. and results in the cured product having a glass transition temperature of at least 140° C. as measured by differential scanning calorimetry (DSC) or dynamic mechanical thermal analysis (DMTA).

In another preferred embodiment of the present invention, the cured product comprises an elongation percentage of at least approximately 1.5%, a tensile strength of at least approximately 40 Mpa, and a tensile modulus of at least approximately 2.5 Gpa.

In yet another preferred embodiment of the present invention, the cured product comprises a flexural strength of at least approximately 55 Mpa, and a flexural modulus of at least approximately 2.2 Gpa.

In one preferred embodiment of the present invention, the cured product comprises a volume resistance of at least approximately 1.5×10¹⁴ Ω·cm, a dielectric constant of at least approximately 2.5, a breakdown voltage of at least approximately 15 kv/mm, and a thermal conductivity of at least approximately 0.2 W/m·K.

In a preferred implementation of the present invention, the cured product comprises a lap shear strength at least approximately 12.0 Mpa at 25° C., 150° C., and 180° C., a lap shear strength at least approximately 8.0 Mpa at 200° C., and a lap shear strength of at least approximately 2.0 Mpa at 230° C.

In another preferred implementation of the present invention, the cured product comprises a hardness at least approximately 70 durometer Shore A.

In yet another preferred implementation of the present invention, the cured product comprises a moisture resistance below approximately 0.3%.

In one preferred implementation of the present invention, the cured product is compliant with flammability requirements to pass UL 94 V-0 standard requirements.

In a preferred embodiment of the present invention, the epoxy resin is present from approximately 25 percent to approximately 60 percent of the total weight of the composition and comprises at least one of a bisphenol A diglycidyl ether epoxy resin, a bisphenol F epoxy resin, a cycloaliphatic epoxy resin, bis(2,3-epoxycyclopentyl) ether, 3,4-epoxycyclohexanemethyl, 3,4-epoxycyclohexanecarboxylate, epoxy novolac, and mixtures thereof.

In another preferred embodiment of the present invention, the non-halogenated phosphorus containing epoxy resin is present from approximately 5 percent to approximately 25 percent of the total weight of the composition.

In yet another preferred embodiment of the present invention, the cyclic anhydride hardening agent is present from approximately 35 percent to approximately 65 percent of the total weight of the composition and comprises at least one of a nadic methyl anhydride, methyl hexahydro phthalic anhydride, tetrahydro phthalic anhydride, hexahydrophthalic anhydride, nonenyl succinic anhydride, trimellitic anhydride, and mixtures thereof.

In one preferred embodiment of the present invention, the catalyst is present from approximately 0.1 percent to approximately 10 percent of the total weight of the composition and comprises at least one of a microencapsulated aromatic polyamine, a tertiary amine, an imidazole, an encapsulated modified imidazole, a 2-phenyl substituted imidazole, a 2-methyl substituted imidazole, 2-ethyl-4-methyl imidazole, and mixtures thereof.

In a preferred implementation of the present invention, the rheology modifier is present from approximately 0.05 percent to approximately 2.0 percent of the total weight of the composition and comprises a polyamide wax based rheology modifier.

In another preferred implementation of the present invention, the heat stabilizing agent is present from approximately 0.05 percent to approximately 2.0 percent of the total weight of the composition and comprises a sterically hindered primary phenolic antioxidant.

In yet another preferred implementation of the present invention, the composition comprises a viscosity of at least 1.5 Pa·s at 25° C. for 90 days without affecting viscosity and gel time of the cured product.

In one preferred implementation of the present invention, the composition comprises a gel time of at least 100 seconds at 150° C.

The present invention is further directed to a storage stable, one-component, solvent-free, non-halogenated, heat curable composition which cures to form a cured product for use in encapsulation of electrical components, comprising, consisting essentially of, and/or consisting of: (a) one or more liquid bis phenol A epoxy resins; (b) one or more liquid non-halogenated flame retardants based on a phosphorus containing epoxy resin; (c) one or more cyclic anhydride curing agents; (d) one or more encapsulated imidazole catalysts; (e) one or more polyamide wax based rheology modifying agents; and (f) one or more sterically hindered primary phenolic stabilizing agents.

In a preferred embodiment of the present invention, the liquid bis phenol A epoxy resin comprises a bisphenol A diglycidyl ether epoxy resin represented by the following chemical structure and derivatives thereof:

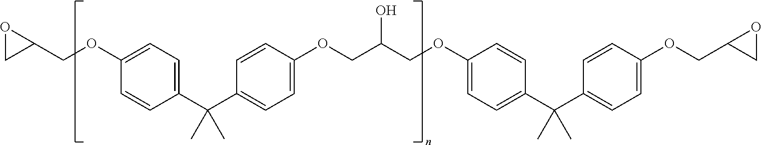

wherein n is 0 or an integer ranging from 1 to approximately 25.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIGS. 1-14 of the drawings are two-dimensional graphs showing heat flow as a function of temperature (DCS—Cure Exotherm/T_{g}) for Experiments 1-7; and

FIG. 15 of the drawings is a two-dimensional graph showing viscosity as a function of time (i.e., storage stability) for Experiments 1-7.

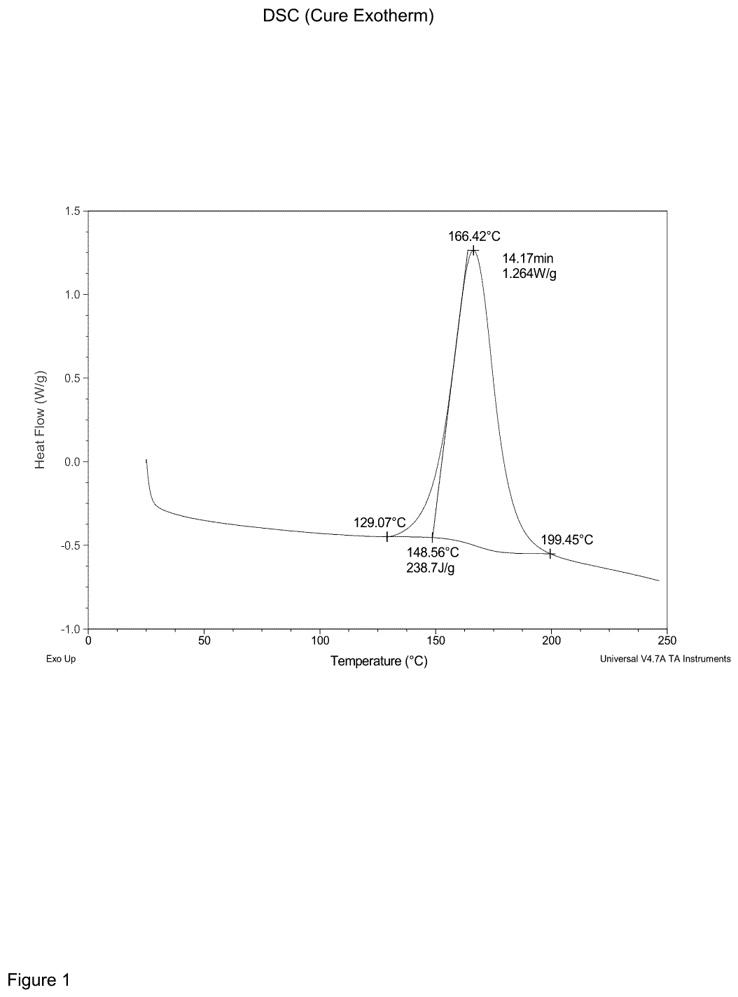

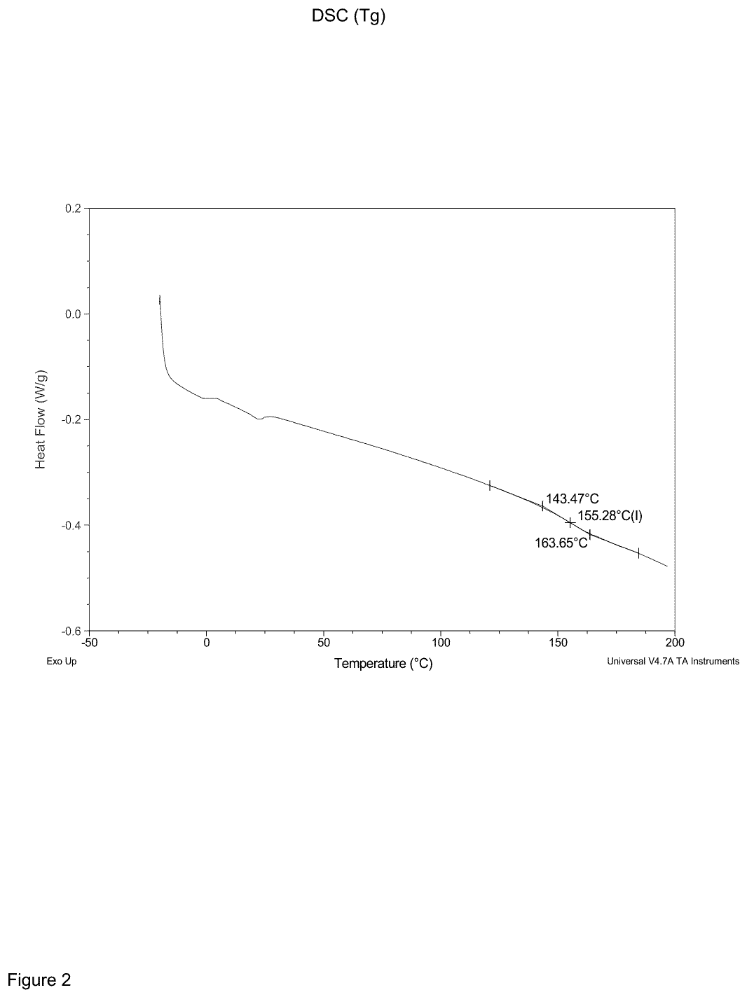

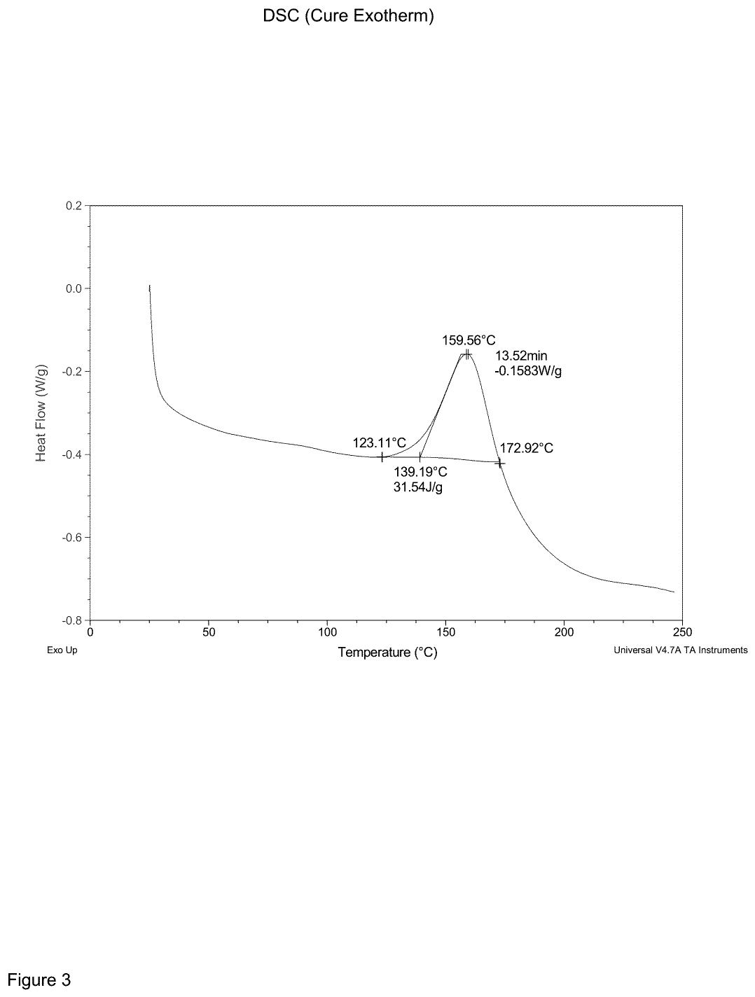

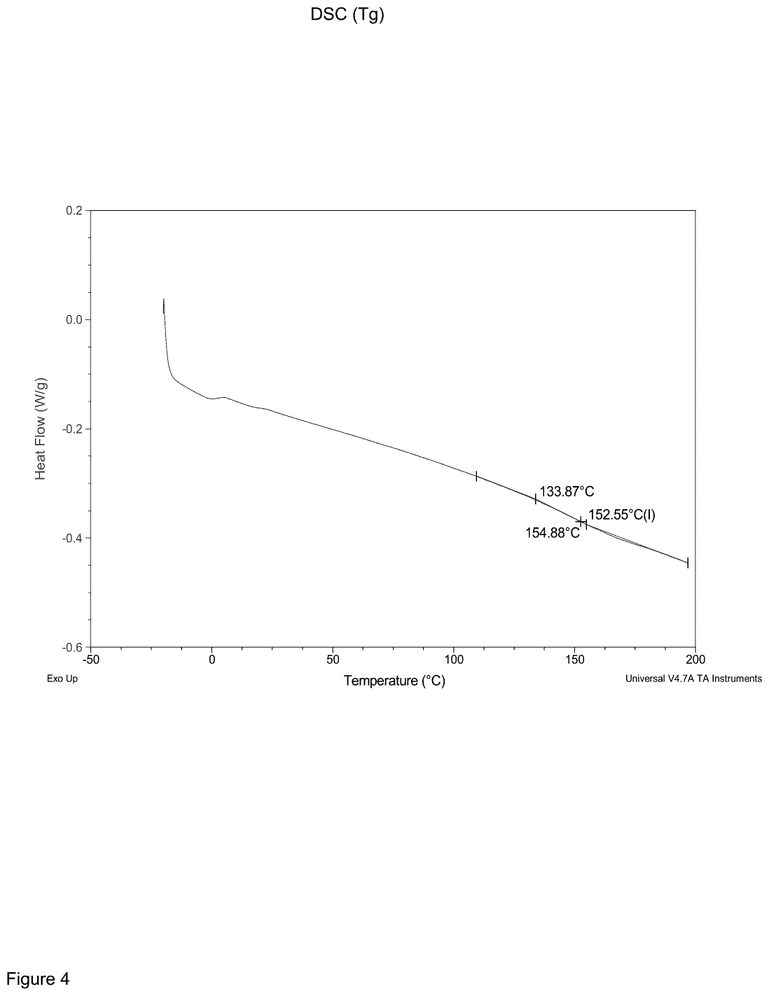

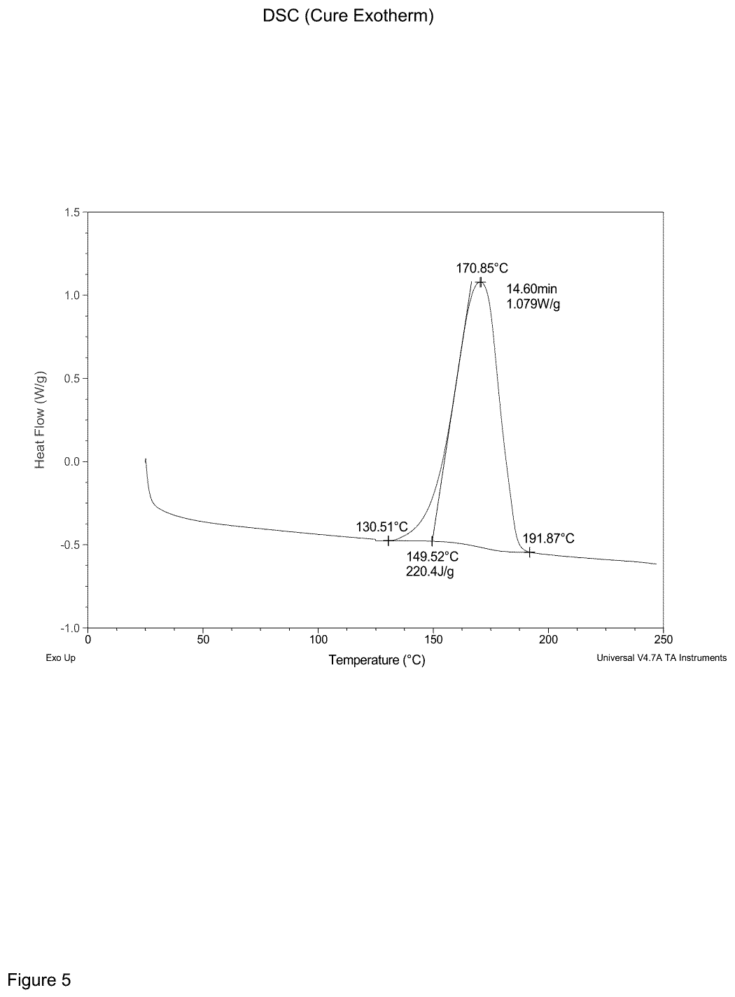

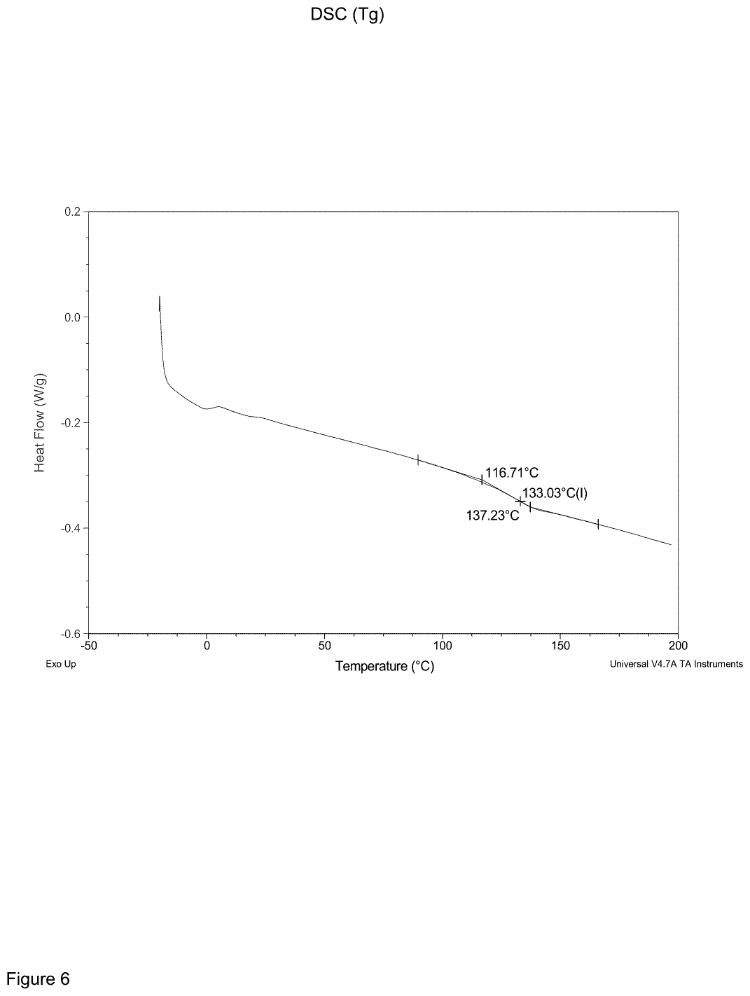

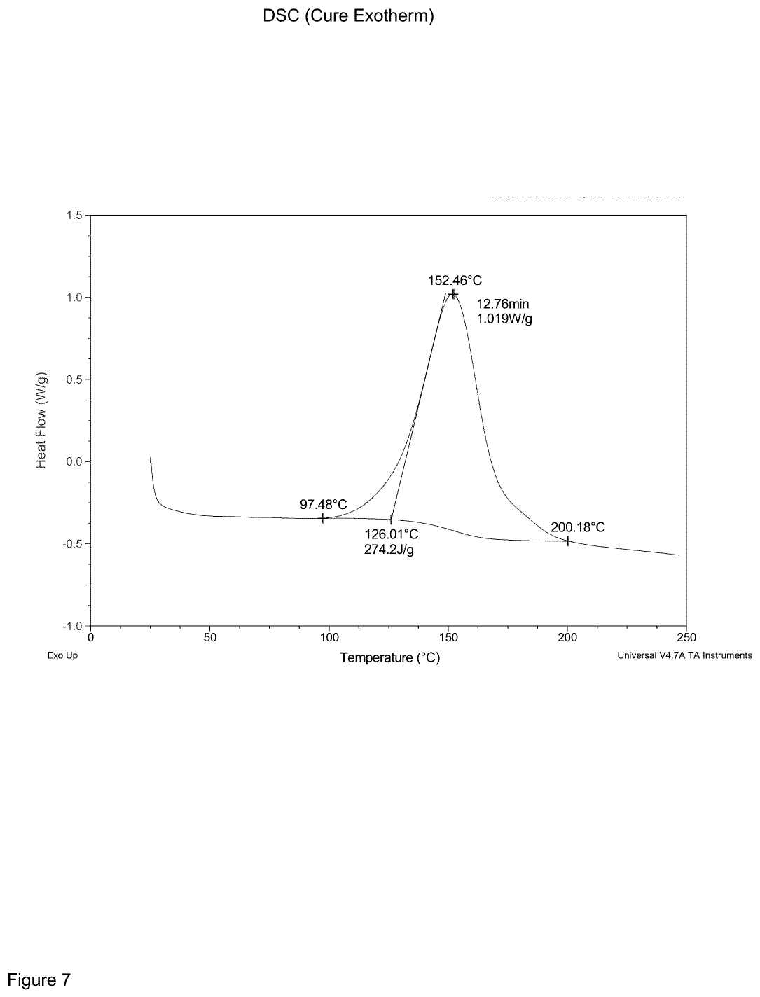

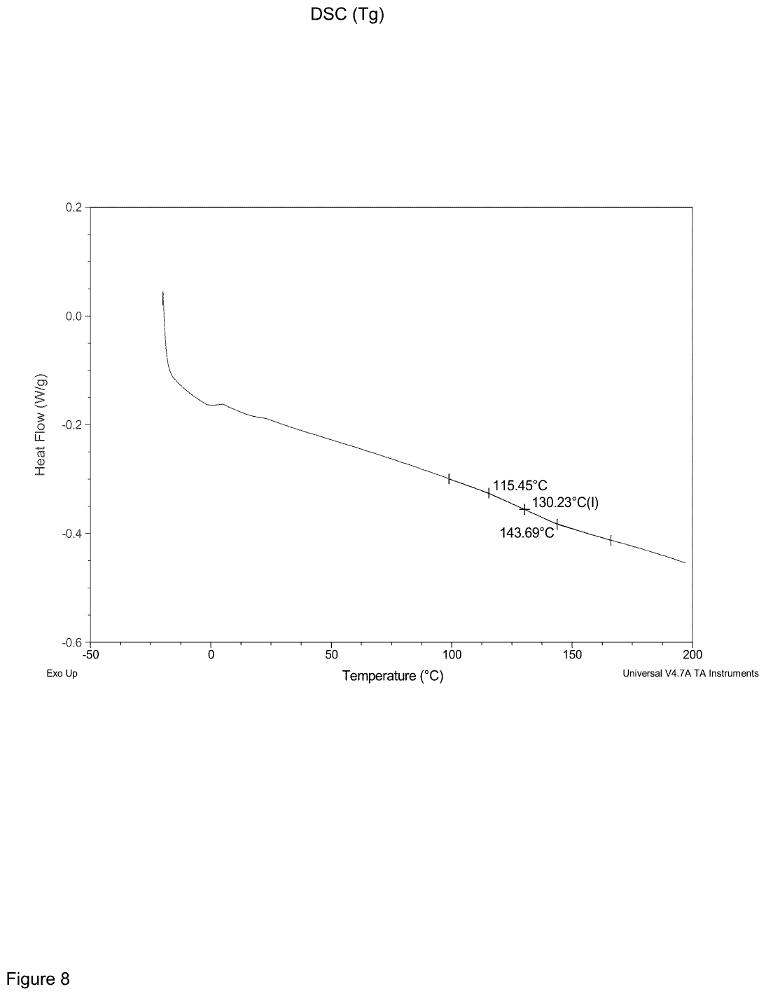

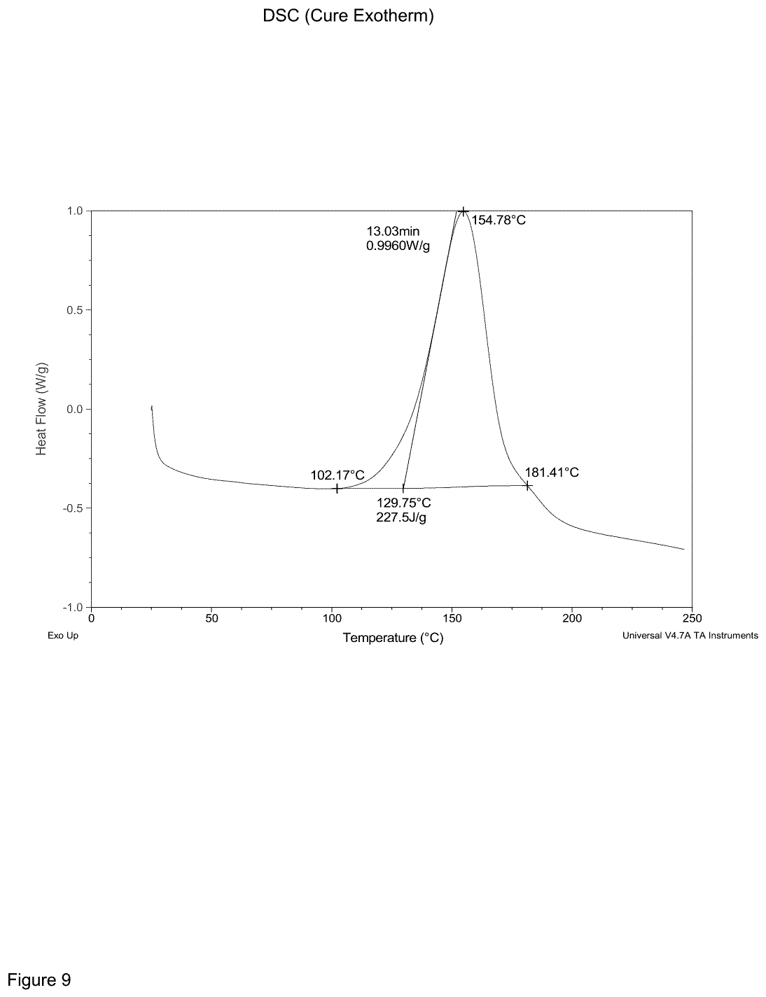

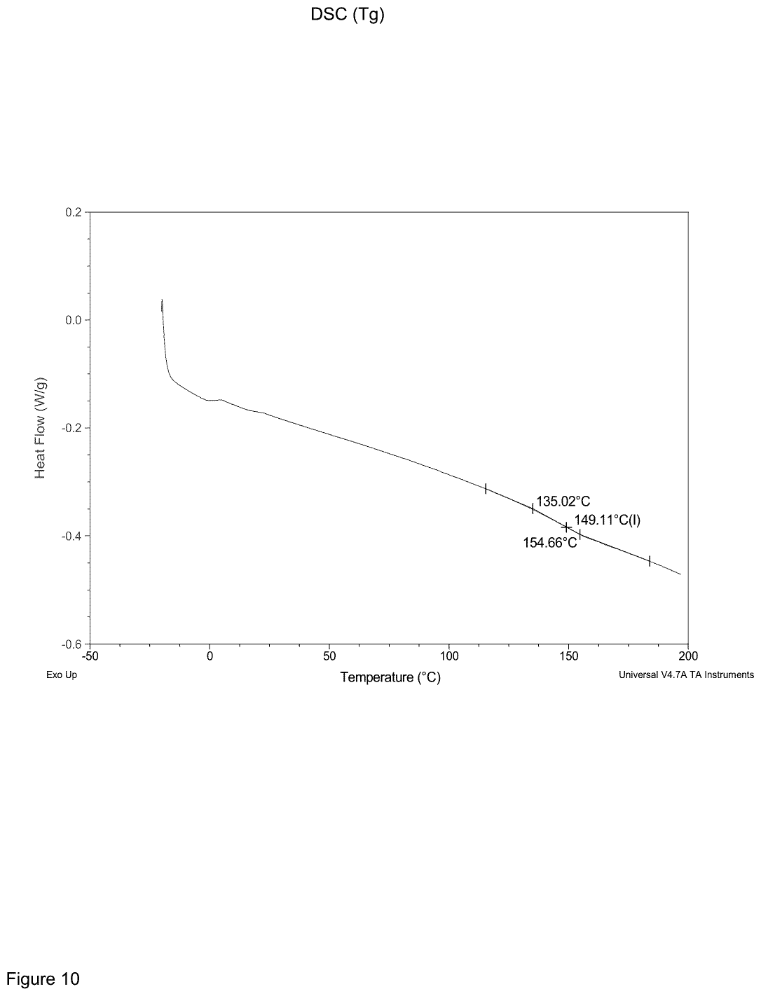

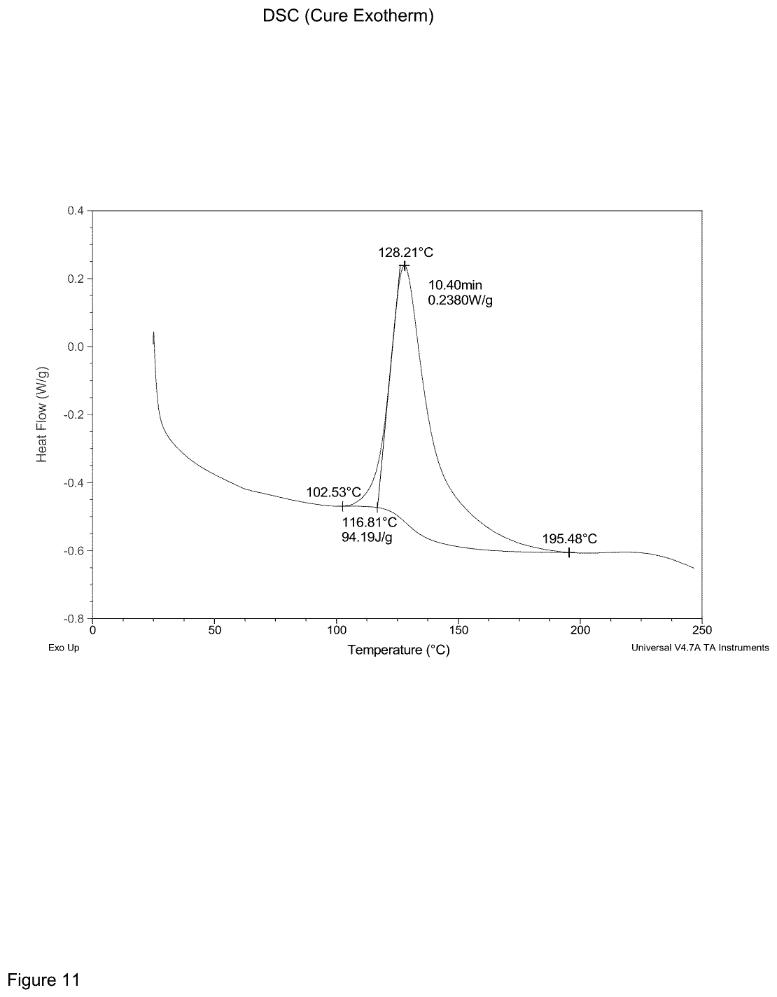

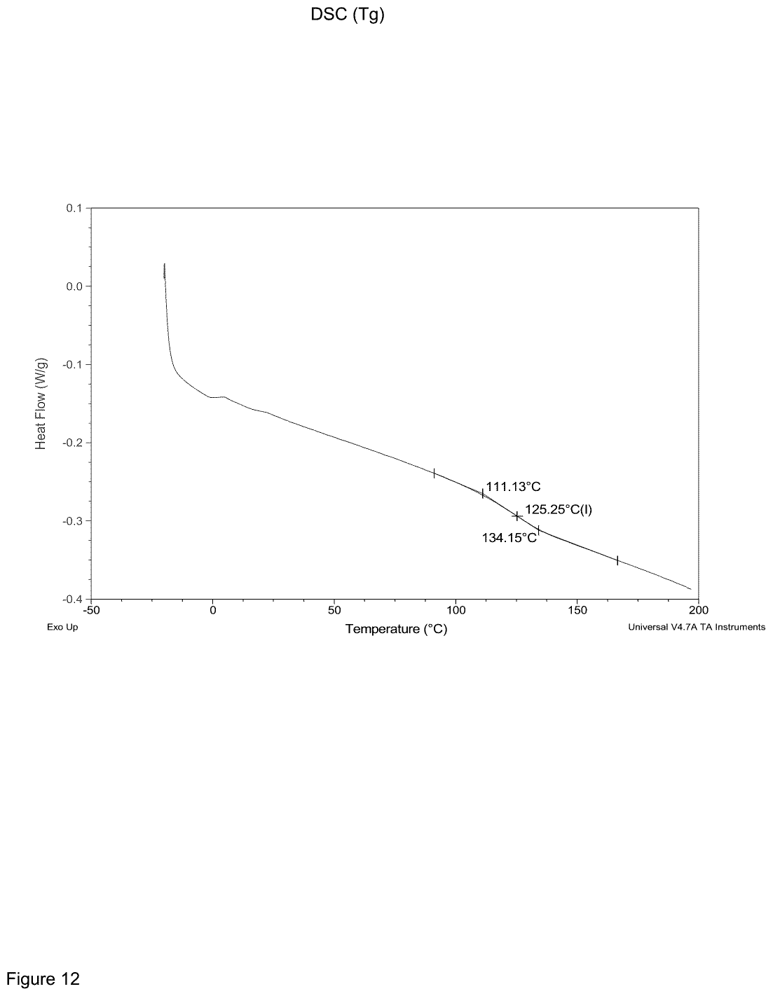

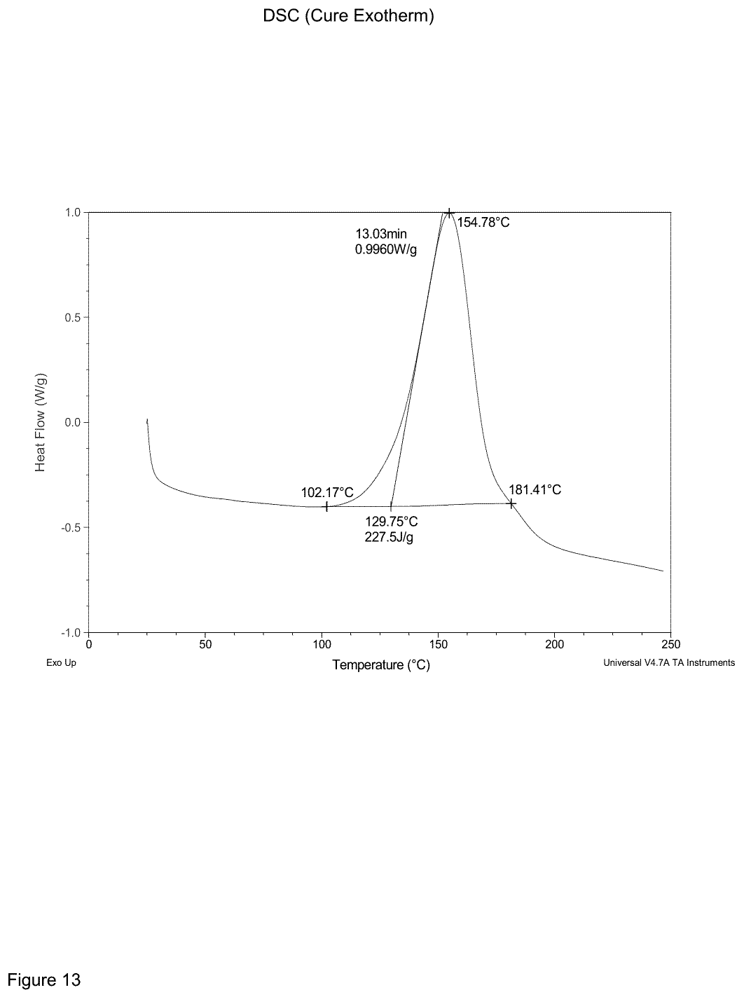

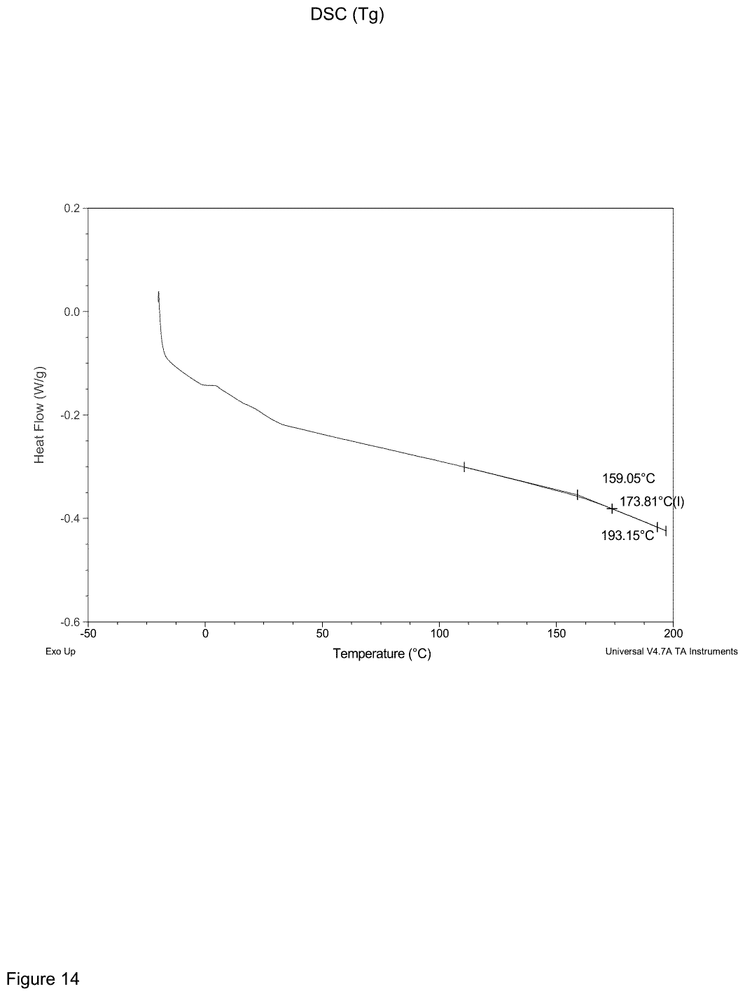

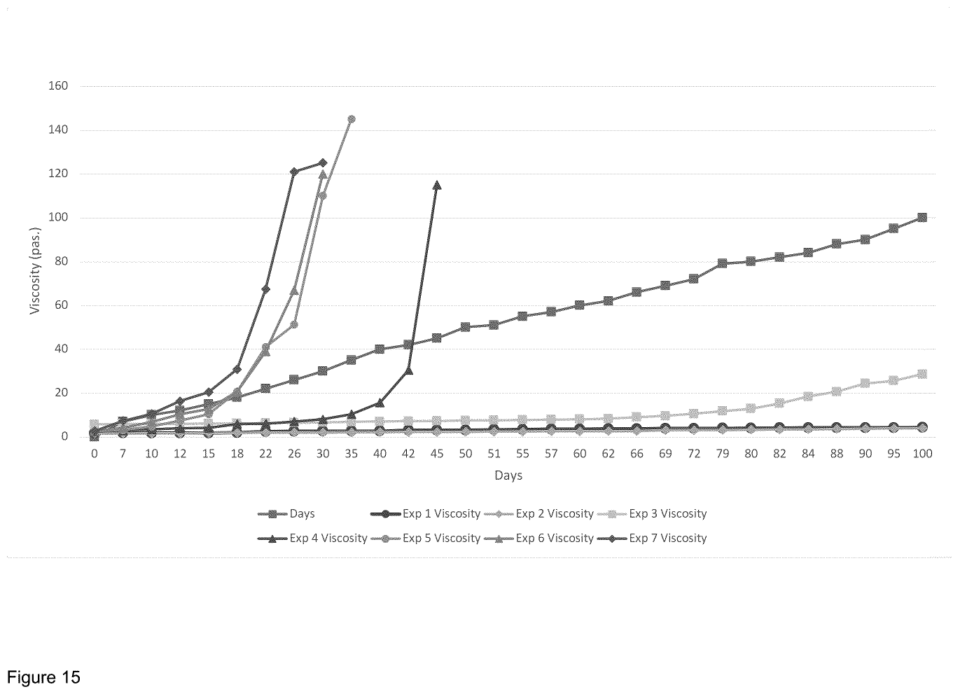

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

As will be discussed and shown experimentally hereinbelow, the present invention is directed to storage stable, one-component, solvent-free, non-halogenated, heat curable compositions which cure to form cured products. These products, among other things, exhibit rapid gelling/curing times, high glass transition temperatures, as well as excellent/superior mechanical, electrical, and flame-retardant properties. The heat curable compositions of the present invention are preferably suitable for use in a plurality of applications, including, but not limited to, the association/impregnation with and/or encapsulation of electric motors, generators, transformers, power supplies, and/or associated sub-components (e.g., insulators, stators, rotors, switchgears, bushings, housings, printed circuit boards, etcetera).

As will be discussed herein below, the heat curable compositions are preferably fabricated from: (1) one or more epoxy resins; (2) one or more non-halogenated flame retardants based on phosphorus containing epoxy resin; (3) one or more cyclic anhydride hardening agents; (4) one or more catalysts; (5) one or more rheology modifiers; (6) one or more heat stabilizing agents; and optionally (7) any adjunct agents.

Components of the storage stable, one-component, solvent-free, non-halogenated, heat curable compositions of the present invention are provided below.

The curable compositions of the present invention preferably include one or more epoxy resins, modified epoxy resins and/or admixtures of resins, including, but not limited to, a cycloaliphatic epoxy resin, a flexibilized cycloaliphatic resin, an epoxy phenolic novolac resin, an epoxy bisphenol A novolac resin, a multifunctional epoxy resin, a bisphenol A epoxy resin, a bisphenol A diglycidyl ether epoxy resin, a bisphenol F epoxy resin, bis(2,3-epoxycyclopentyl) ether, 3,4-epoxycyclohexanemethyl, 3,4-epoxycyclohexanecarboxylate, epoxy novolac, and mixtures thereof.

In a preferred embodiment of the present invention, the epoxy resins comprise one or more bisphenol A type liquid epoxy resins. In one embodiment of the present invention, the bisphenol A type liquid epoxy resin preferably comprises a diglycidyl ether of bisphenol A. Non-limiting examples of bisphenol A type liquid resins include Kukdo YD-128 (Kukdo Chemical), DER 330 (Olin Corporation), DER 331 (Olin Corporation), DER 332 (Olin Corporation), DER 383 (Olin Corporation), DER 3171 (Olin Corporation), DER 317 (Olin Corporation), DER 321 (Olin Corporation), DER 3212 (Olin Corporation), DER 322 (Olin Corporation), DER 323 (Olin Corporation), DER 324 (Olin Corporation), DER 325 (Olin Corporation), DER 326 (Olin Corporation), DER 3274 (Olin Corporation), DER 333 (Olin Corporation), DER 3401 (Olin Corporation), DER 346 (Olin Corporation), DER 362 (Olin Corporation), and EPON 825 (Miller-Stephenson).

In a preferred embodiment of the present invention, the bisphenol A diglycidyl ether epoxy resin is represented by the following chemical structure and derivatives thereof:

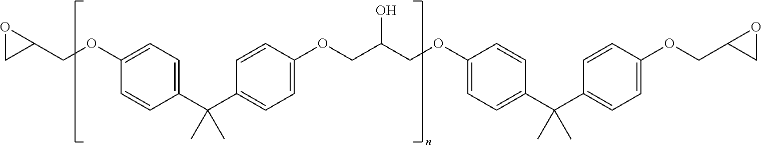

wherein n is 0 or an integer ranging from 1 to approximately 25.

In one preferred embodiment of the present invention, the epoxy resin(s) are present from approximately (i.e., +/−5%) 25 percent to approximately (i.e., +/−5%) 60 percent of the total weight of the composition, and more preferably present from approximately (i.e., +/−5%) 35 percent to approximately (i.e., +/−5%) 50 percent of the total weight of the composition.

The curable compositions of the present invention preferably include one or more flame retardant epoxy resins. Preferably, the flame retardant epoxy resins comprise a non-halogenated phosphorus containing epoxy resin, such as Exolit EP 360 (Clariant) and/or Exolit EP 390 (Clariant).

In a preferred embodiment of the present invention, the flame retardant epoxy resin is represented by the following chemical structure and derivatives thereof:

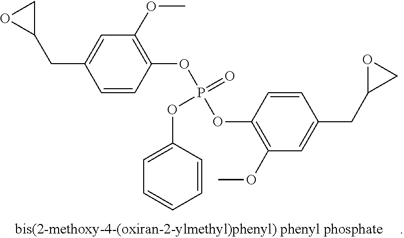 [SMILES: COc1cc(CC2CO2)ccc1OP(=O)(Oc1ccccc1)Oc1ccc(CC2CO2)cc1OC]

In one preferred embodiment of the present invention, the flame retardant epoxy resin(s) are present from approximately (i.e., +/−1%) 2 percent to approximately (i.e., +/−5%) 25 percent of the total weight of the composition, and more preferably present from approximately (i.e., +/−0.5%) 2 percent to approximately (i.e., +/−1%) 10 percent of the total weight of the composition.

The curable compositions of the present invention preferably include one or more hardening agents. Preferably, the hardening agent is represented by one or more of the following chemical structures and derivatives thereof:

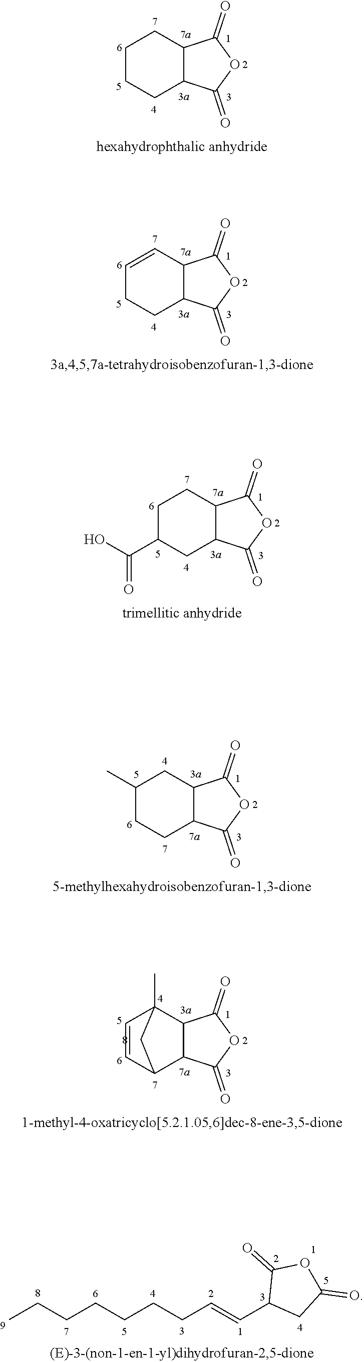 [SMILES: O=C1OC(=O)C2CCCCC12 ; O=C1OC(=O)C2CCC=CC12 ; O=C(O)C1CCC2C(=O)OC(=O)C2C1 ; CC1CCC2C(=O)OC(=O)C2C1 ; CC12C=CC(C1)C1C(=O)OC(=O)C12 ; CCCCCCC/C=C/C1CC(=O)OC1=O]

The compositions of the present invention may include, for example, cyclic anhydrides of aromatic, aliphatic, cycloaliphatic and heterocyclic polycarbonic acids which may or may not be substituted with alkyl, alkenyl, or halogen groups. Examples of anhydride curing agents include phthalic anhydride, tetrahydrophthalic anhydride, methyl tetrahydrophthalic anhydride, hexahydrophthalic anhydride, methyl hexahydrophthalic anhydride, nadic methyl anhydride, Succinic anhydride, dodecenylsuccinic anhydridem, glutaric anhydride, pyromellitic anhydride, maleic anhydride, isatoic anhydride, benzophenonetetra carboxylic anhydride, and mixtures thereof. Additional curing agents useful in the present invention include the anhydride curing agents described in U.S. Pat. No. 6,852,415 entitled “Casting Compound Based on Thermosetting Epoxy Resins—all of which is hereby incorporated herein by reference in its entirety including all references cited therein. In one embodiment, the liquid cyclic tetrahydrophthalic anhydride, methyl anhydride curing agents include tetrahydrophthalic anhydride, hexahydrophthalic anhydride, methyl hexahydrophthalic anhydride, nadic methyl anhydride, and mixtures thereof. In another embodiment, the liquid cyclic anhydride curing agents include tetrahydrophthalic anhydride, methyl tetrahydrophthalic anhydride, nadic methyl anhydride, and mixtures thereof. In still another embodiment, the liquid cyclic anhydride curing agent includes methyl tetrahydrophthalic anhydride and nadic methyl anhydride and mixtures thereof. In yet another embodiment, the liquid cyclic anhydride curing agent includes nadic methyl anhydride and mixtures thereof.

In one preferred embodiment of the present invention, the hardening agent(s) are present from approximately (i.e., +/−5%) 35 percent to approximately (i.e., +/−5%) 65 percent of the total weight of the composition, and more preferably present from approximately (i.e., +/−5%) 40 percent to approximately (i.e., +/−5%) 50 percent of the total weight of the composition.

The curable compositions of the present invention preferably include one or more catalysts. Preferably, the catalysts comprise at least one of a modified and/or unmodified imidazole, a microencapsulated imidazole, a microencapsulated aromatic polyamine, a modified amine and/or unmodified amine catalyst, a microencapsulated amine catalyst (Novacure HX 3088, HX 3748, HX 3742, HX 3722 already dispersed in epoxy resin (Asahi Kasei Corporation)), a tertiary amine, an encapsulated modified imidazole (LC-80 (ACCI Specialty Materials)), and mixtures thereof.

Provided below are non-limiting examples of structural formulas for catalysts of the present invention:

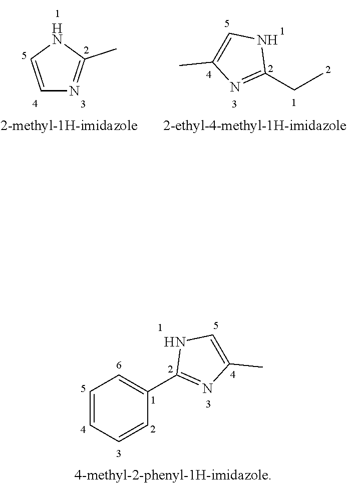

Additional non-limiting examples of suitable catalysts include 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, isopropyl imidazole, cyanide-containing derivatives of imidazole's (e.g., 1-cynoethyl-2-methylimidazole, 1-cyanoethyl-2-undecylimidazole, 1-cyanoethyl-2-ethyl-4-methylimidazole, and 1-cyanoethyl-2-phenylimidazole), azine-containing derivatives of imidazole's (e.g., 2,4-diamino-6-[2′methylimidazolyl-(1′)]-ethyl-s-triazine, 2,4-diamino-6-[2′-undecylimidazolyl-(1′)]-ethyl-s-trizine, 2,4-diamino-6-[2′-ethyl-4′-methylimidazolyl-(1′)]-ethyl-s-triazine, 2,4-diamino-6-vinyl-1,3,5-triazine, and 2,4-diamino-6-methaeryloyloxyethyl-1,3,5-triazine), hydroxyl-containing derivatives of imidazole's (e.g., 2-phenyl-4,5-dihydroxymethylimidazol, and 2-phenyl-4-methyl-5-hydromethylimidazole adduct), and adducts of an imidazole (e.g., 2,4-diamino-6-vinyl-1,3,5-triazine isocyanuric acid, 2,4-diamino-6-methaeryloyloxyethyl-1,3,5-trizine isocyanuric acid adduct, epoxy-resin imidazole adduct, 2,4-diamino-6-[2′-methyl imidazolyl-(1′)]-ethyl-s-trizine isocyanuric acid adduct dehydrate, and 2-phenylimidazole isocyanuric acid adduct). In other embodiments, the catalyst is or comprises 2-methylimidazole. In some embodiments, the catalyst is or comprises a tertiary amine. Any tertiary amine known in the art for catalyzing the curing of epoxy resins can be used herein. Some non-limiting examples of suitable tertiary amine catalysts include benzyldimethyl amine, 2,2-(dimethylamine methyl) phenol, 2,4,6-tris(dimethylamine methyl) phenol, triethanolamine, triethylamine, triethylenediamine and combinations thereof.

In one preferred embodiment of the present invention, the catalysts are present from approximately (i.e., +/−0.05%) 0.1 percent to approximately (i.e., +/−1%) 10 percent of the total weight of the composition, and more preferably present from approximately (i.e., +/−0.05%) 1.0 percent to approximately (i.e., +/−1%) 5 percent of the total weight of the composition.

The curable compositions of the present invention preferably include one or more rheology modifiers. Preferably, the rheology modifiers comprise a non-reactive polyamide thixotrope, such as Disparlon 6500 (Kusumoto Chemical). The rheology modifiers of the present invention preferably provide strong anti-sagging and anti-slumping properties without adversely affecting shelf life of the curable composition and/or durability/aging of the cured product.

In one preferred embodiment of the present invention, the rheology modifiers are present from approximately (i.e., +/−0.01%) 0.05 percent to approximately (i.e., +/−0.1%) 5 percent of the total weight of the composition, and more preferably present from approximately (i.e., +/−0.01%) 0.05 percent to approximately (i.e., +/−0.1%) 2 percent of the total weight of the composition.

The curable compositions of the present invention preferably include one or more heat stabilizers which protect against thermo-oxidative degradation. Preferably, the heat stabilizers comprise a sterically hindered primary phenolic antioxidant. Non-limiting examples of suitable heat stabilizers/antioxidants include IRGANOX 245 (2-[2-[2-[3-(3-tert-butyl-4-hydroxy-5-methylphenyl) propanoyloxy]ethoxy]ethoxy]ethyl 3-(3-tert-butyl-4-hydroxy-5-methylphenyl) propanoate) (a sterically hindered phenol or amine derivative), IRGANOX 1010, IRGANOX 1076, IRGANOX MD 1024, and IRGANOX PS 800. These antioxidants are commercially available from BASF.

Provided below are non-limiting examples of structural formulas for heat stabilizers/antioxidants of the present invention:

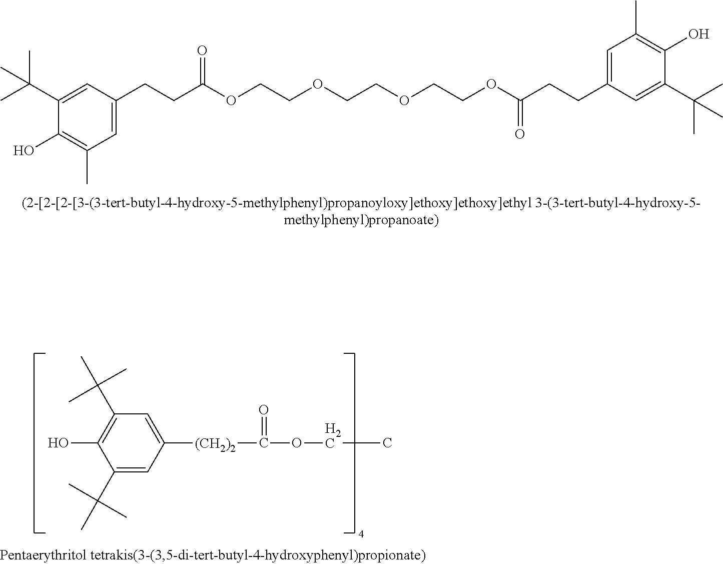

In one preferred embodiment of the present invention, the heat stabilizers/antioxidants are present from approximately (i.e., +/−0.01%) 0.05 percent to approximately (i.e., +/−0.1%) 5 percent of the total weight of the composition, and more preferably present from approximately (i.e., +/−0.01%) 0.05 percent to approximately (i.e., +/−0.1%) 2 percent of the total weight of the composition.

The invention is further described by the following experiments and examples.

### Glass Transition Temperature (T) Measurements

Using a TA Instrument, DSC Q100 was used to measure TG and cure exotherm of the heat curing varnish. A portion of the cured epoxy formulation was placed in a differential scanning calorimeter (DSC) with heating and cooling at 10° C./minute at a first heating scan of from 25° C. to 250° C. to a second heating scan of from 25° C. to 250° C. Tg was reported TG method: −20° C. to 200° C., 10 C/min.

### Flexural Property Measurements

Flexural property measurements were carried out on the cured epoxy formulation according to ASTM D790 using strain rate of 5 mm/minute.

### Tensile Property Measurements

Tensile property measurements were carried out on the cured epoxy formulation according to ASTM D638 using a Type 1 tensile bar with strain rate of 5 mm/minute.

### Tensile Shear Strength Measurements

Tensile shear strength measurements were carried out on the cured epoxy formulation according to SAE J1523 strain rate of 5 mm/minute.

### Volume Resistance

Volume Resistance was measured at room temperature on an IET Labs 1865+ Megohmmeter.

### Dielectric Constant

Dielectric constant was measured at room temperature on an IET Labs 7600 Plus LCR Meter.

### Break Down Voltage

Break down voltage was measured at room temperature on Haefely Hipotronics D149.

### Dissipation Factor

Dissipation factor was measured at room temperature on an IET Labs 7600 Plus LCR meter.

### Rheoglogy Measurements

Rheoglogy measurements were carried out using a TA Instruments AR2000EX Rheometer with a parallel plate fixture. The plate diameter was 40 mm diameter plate with 1,000 micron gap and running in flow mode at shear rates of 1.5 l/second and at a temperature of at 25° C./minute.

### Flammability-UL-94 Vertical Flame Test

A 5-centimeter (cm) long×1 cm wide×1.5 millimeter (mm) thick 8-ply laminate sample was prepared and conditioned in a 105° C. oven for 8 hours prior to analysis. The sample was supported in a vertical position and a flame was applied to the bottom of the sample. A first flame was applied for ten seconds and then removed until flaming stopped at which time a second flame was applied for another ten seconds and then removed. Five samples were prepared and tested. The results are reported as a 1^{st} Burn Time and a 2^{nd} Burn Time and a UL94 rating is determined. The 1^{st} Burn Time is the time (in seconds) it takes for the flaming to stop after the first flame has been removed. Similarly, the 2^{nd} Burn Time is the time (in seconds) it takes for the flaming to stop after the second flame has been removed.

### Mixing Procedure

Experimental formulations were prepared by mixing the epoxy resins, curing agents and other additives, as indicated in Table 1 below.

TABLE 1
Composition

| | Commercial | | | | | | | | |
|---|---|---|---|---|---|---|---|---|---|
| No. | Name | Chemical description | Exp 1 | Exp 2 | Exp 3 | Exp 4 | Exp 5 | Ep 6 | Exp 7 |
| 1 | Kukdo YD 128 | Bis phenol A liquid epoxy | 44 | 0 | 39 | 47 | 47 | 47 | 47 |
| | | resin | | | | | | | |
| 2 | Sinepoxy CER- | Cycloaliphatic epoxy resin | 0 | 44 | 0 | 0 | 0 | 0 | 0 |
| | 421 | | | | | | | | |
| 3 | IPN -11 | Epoxy end capped | 0 | 0 | 5 | 0 | 0 | 0 | 0 |
| | | polyurethane | | | | | | | |
| 4 | Polynt - METH | Cyclic anhydride curing | 45.5 | 45.5 | 45.5 | 46 | 46 | 46 | 46 |
| | E | agent | | | | | | | |
| 5 | Novacure HX | Microencapsulated | 5 | 5 | 5 | 0 | 0 | 0 | 0 |
| | 3088 | aromatic polyamine | | | | | | | |
| | | compound | | | | | | | |
| 6 | Technicure LC | Encapsulated modified | 0 | 0 | 0 | 1.5 | 0 | 0 | 0 |
| | 80 | imidazole | | | | | | | |
| 7 | Curezol - | 2-Phenyl Substituted | 0 | 0 | 0 | 0 | 1.5 | 0 | 0 |
| | 2P4MZ | imidazole | | | | | | | |
| 8 | Resicure -2MI | 2-Methyl Substituted | 0 | 0 | 0 | 0 | 0 | 1.5 | 0 |
| | | imidazole | | | | | | | |
| 9 | Imicure - | 2-ethyl-4-methyl Imidazole | 0 | 0 | 0 | 0 | 0 | 0 | 1.5 |
| | EMI24 | | | | | | | | |
| 10 | Disparlon 6500 | Polyamide wax based | 0.4 | 0.4 | 0.4 | 0.4 | 0.4 | 0.4 | 0.4 |
| | | rheological additive | | | | | | | |
| 11 | Irganox 1076 | Sterically hindered primary | 0.1 | 0.1 | 0.1 | 0.1 | 0.1 | 0.1 | 0.1 |
| | | phenolic antioxidant | | | | | | | |
| | | stabilizer | | | | | | | |
| 12 | Exolit EP 360 | Non-halogenated flame | 5 | 5 | 5 | 5 | 5 | 5 | 5 |
| | | retardant with epoxy | | | | | | | |
| | | functionality | | | | | | | |

Novacure HX 3088 (70% of liquid epoxy and 30% of microencapsulated aromatic polyamine blend), IPN 11 (Epoxy end capped polyurethane prepolymer made by Uniseal), curing condition −100° C.×1 hr+150° C.×1 hr+180° C.×3 hr.

### Experiment 1

At ambient temperatures YD128 epoxy (a bisphenol-A based epoxy resin (reaction product of epichlorohydrin and bisphenol-A) resin having about 44 weight percent available from Kukdo chemical Company, Korea, add METH E anhydride curing agent (Nadic methyl anhydride) having 45.5 weight percent, available from POLYNT INTERMEDIATES & SPECIALTIES, Cavaglià, Scanzorosciate-Italy, mix the composition for 30 minutes, add 0.4 weight percent Disparion 6500 (polyamide wax based rheological additive) available from Kusomoto chemical Itd, Japan, and 5 weight percent Exolit 360 (phosphorus based flame retardant with epoxy functional) available from Clariant chemicals, Switzerland, then mix the composition at 50° C.-70° C. for 30 minutes, after mixing bring the composition to room temperature or below 25° C. then add 5 weight percent Novacure HX 3088 latent hardener (Microencapsulated polyamine-epoxy compound) available Asahi kasei corporation, Japan, mix the composition for 30 minutes at below 25° C. temperature, then add 0.1 weight percent Irganox 1076 (phenolic antioxidant stabilize) available from BASF chemical company, Germany, mix the composition for 20 minutes at 25° C. temperature. The mixtures were degassed and then used for testing.

### Experiment 2

At ambient temperatures Sinepoxy® CER-421 (3,4-Epoxycyclohexanemethyl 3,4-epoxycyclohexanecarboxylate) resin having about 44 weight percent available chemical from Sinocure group, Limited, Hongkong, China, add METH E anhydride curing agent (Nadic methyl anhydride) having 45.5 weight percent, available from Polynt Intermediates & Specialties, Cavaglià, Scanzorosciate-Italy, mix the composition for 30 minutes, add 0.4 weight percent disparlon 6500 (polyamide wax based rheological additive) available from Kusomoto chemical Itd. Japan, and 5 weight percent Exolit 360 (phosphorus based flame retardant with epoxy functional) available from Clariant chemicals, Switzerland, then mix the composition at 50° C.-70° C. for 30 minutes, after mixing bring the composition to room temperature or below 25° C. then add 5 weight percent Novacure HX 3088 latent hardener (Microencapsulated polyamine-epoxy compound) available Asahi kasei corporation, Japan, mix the composition for 30 minutes at below 25° C. temperature, then add 0.1 weight percent Irganox 1076 (phenolic antioxidant stabilize) available from BASF chemical company, Germany, mix the composition for 20 minutes at 25° C. temperature. The mixtures were degassed and then used for testing.

### Experiment 3

At ambient temperatures. Kukdo YD 128 epoxy (a bisphenol-A based epoxy resin, reaction product of epichlorohydrin and bisphenol-A) resin having about 39 weight percent available from Kukdo chemical Company, Korea, add 5 weight percent IPN 11 (Epoxy end capped Polyurethane polymer) made Uniseal, LG chem America, Evansville, mix the composition for 20 minutes, add METH E anhydride curing agent (Nadic methyl anhydride) having 45.5 weight percent, available from Polynt Intermediates & Specialties, Cavaglià, Scanzorosciate-Italy, mix the composition for 30 minutes, add 0.4 weight percent Disparlon 6500 (polyamide wax based rheological additive) available from Kusomoto chemical Itd, Japan, and 5 weight percent Exolit 360 (phosphorus based flame retardant with epoxy functional) available from Clariant chemicals, Switzerland, then mix the composition at 50° C.-70° C. for 30 minutes, after mixing bring the composition to room temperature or below 25° C. then add 5 weight percent Novacure HX 3088 latent hardener (Microencapsulated polyamine-epoxy compound) available Asahi kasei corporation, Japan, mix the composition for 30 minutes at below 25° C. temperature, then add 0.1 weight percent Irganox 1076 (phenolic antioxidant stabilize) available from BASF chemical company, Germany, mix the composition for 20 minutes at 25° C. temperature. The mixtures were degassed and then used for testing.

### Experiment 4

At temperatures YD128 epoxy (a bisphenol-A based epoxy resin, reaction product of epichlorohydrin and bisphenol-A) resin having about 47 weight percent available from Kukdo chemical Company, Korea, add METH E anhydride curing agent (Nadic methyl anhydride) having 45.5 weight percent, available from Polynt lintermediates & Specialties, Cava glia, Scanzorosciate-Italy, mix the composition for 30 minutes, add 0.4 weight percent Disparlon 6500 (polyamide wax based rheological additive) available from Kusomoto chemical Itd, Japan, and 5 weight percent Exolit 360 (phosphorus based flame retardant with epoxy functional) available from Clariant chemicals, Switzerland, then mix the composition at 50° C.-70° C. for 30 minutes, after mixing bring the composition to room temperature or below 25° C. then add 1.5 weight percent Technicure-LC80 latent hardener (Encapsulated modified Imidazole catalyst) available from ACCI Specialty materials, New jersey, mix the composition for 30 minutes at below 25° C. temperature, then add 0.1 weight percent Irganox 1076 (phenolic antioxidant stabilize) available from BASF chemical company, Germany, mix the composition for 20 minutes at 25° C. temperature. The mixtures were degassed and then used for testing.

### Experiment 5

At ambient temperatures YD128 epoxy (a bisphenol-A based epoxy resin, reaction product of epichlorohydrin and bisphenol-A) resin having about 47 weight percent available from Kukdo chemical Company, Korea, add METH E anhydride curing agent (Nadic methyl anhydride) having 45.5 weight percent, available from Polynt lintermediates & Specialties, Cavaglià, Scanzorosciate-Italy, mix the composition for 30 minutes, add 0.4 weight percent Disparlon 6500 (polyamide wax based rheological additive) available from Kusomoto chemical Itd, Japan, and 5 weight percent Exolit 360 (phosphorus based flame retardant with epoxy functional) available from Clariant chemicals, Switzerland, then mix the composition at 50° C.-70° C. for 30 minutes, after mixing bring the composition to room temperature or below 25° C. then add 1.5 weight percent Curezol 2P4 MZ latent hardener (Phenyl substituted Imidazole catalyst) available from EVONIK CORPORATION, PA, USA, mix the composition for 30 minutes at below 25° C. temperature, then add 0.1 weight percent Irganox 1076 (phenolic antioxidant stabilize) available from BASF chemical company, Germany, mix the composition for 20 minutes at 25° C. temperature. The mixtures were degassed and then used for testing.

### Experiment 6

At ambient temperatures YD128 epoxy (a bisphenol-A based epoxy resin, reaction product of epichlorohydrin and bisphenol-A) resin having about 47 weight percent available from Kukdo chemical Company, Korea, add METH E anhydride curing agent (Nadic methyl anhydride) having 45.5 weight percent, available from Polynt lintermediates & Specialties, Cavaglià, Scanzorosciate-Italy, mix the composition for 30 minutes, add 0.4 weight percent Disparlon 6500 (polyamide wax based rheological additive) available from Kusomoto chemical Itd, Japan, and 5 weight percent Exolit 360 (phosphorus based flame retardant with epoxy functional) available from Clariant chemicals, Switzerland, then mix the composition at 50° C.-70° C. for 30 minutes, after mixing bring the composition to room temperature or below 25° C. then add 1.5 weight percent Techicure—2 MI latent hardener (Methyl substituted Imidazole catalyst) available from ACCI Specialty materials, New jersey, mix the composition for 30 minutes at below 25° C. temperature, then add 0.1 weight percent Irganox 1076 (phenolic antioxidant stabilize) available from BASF chemical company, Germany, mix the composition for 20 minutes at 25° C. temperature. The mixtures were degassed and then used for testing

### Experiment 7

At ambient temperatures YD128 epoxy (a bisphenol-A based epoxy resin, reaction product of epichlorohydrin and bisphenol-A) resin having about 47 weight percent available from Kukdo chemical Company, Korea, add METH E anhydride curing agent (Nadic methyl anhydride) having 45.5 weight percent, available from Polynt lintermediates & Specialties, Cavaglià, Scanzorosciate-Italy, mix the composition for 30 minutes, add 0.4 weight percent Disparion 6500 (polyamide wax based rheological additive) available from Kusomoto chemical Itd, Japan, and 5 weight percent Exolit 360 (phosphorus based flame retardant with epoxy functional) available from Clariant chemicals, Switzerland, then mix the composition at 50° C.-70° C. for 30 minutes, after mixing bring the composition to room temperature or below 25° C. then add 1.5 weight percent Imicure-EMI24 latent hardener (2-ethyl-4-methyl Imidazole catalyst) available from EVONIK CORPORATION, PA, USA, mix the composition for 30 minutes at below 25° C. temperature, then add 0.1 weight percent Irganox 1076 (phenolic antioxidant stabilize) available from BASF chemical company, Germany, mix the composition for 20 minutes at 25° C. temperature. The mixtures were degassed and then used for testing.

TABLE 2
Test Results

| | Test | | | | | | | | | | | | | | |
|---|---|---|---|---|---|---|---|---|---|---|---|---|---|---|---|
| Test properties | method | Exp 1 | | Exp 2 | | Exp 3 | | Exp4 | | Exp 5 | | Exp6 | | Exp7 | |
| Viscosity at 25° | Rheometer | 1.66 | | 1.5 | | 5.8 | | 2.41 | | 2.68 | | 2.64 | | 2.62 | |
| C. (Pa · s) | | | | | | | | | | | | | | | |
| Pot life /Storage | @ 25C | 90 | days | 100 | days | 60 | days | 20 | days | 5 | days | 3 | days | 10 | days |
| stability | | | | | | | | | | | | | | | |
| Gel time | Hot plate | 124 | sec | 150 | sec | 130 | sec | 205 | sec | 220 | sec | 110 | sec | 113 | sec |
| at150° C., (sec) | | | | | | | | | | | | | | | |
| Glass transition | DSC | 155° | C. | 153° | C. | 133° | C. | 130° | C. | 149° | C. | 125° | C. | 174° | C. |

| Temperature | | | | | | | | |
|---|---|---|---|---|---|---|---|---|
| (Tg), C. | | | | | | | | |
| Hardness | Durometer | 84 | 80 | 80 | 81 | 82 | 83 | 82 |
| (Shore D) | | | | | | | | |
| Flexural strength | ASTM | 65 | 70 | 62 | 55 | 50 | 48 | 50 |
| (Mpa) | D 790 | | | | | | | |
| Flexural | | 2.5 | 2.6 | 2.4 | 2.8 | 2.7 | 1.8 | 2.3 |
| modulus (Gpa) | | | | | | | | |
| Tensile strength | ASTM | 45 | 45 | 43 | 44 | 27 | 29 | 44 |
| (Mpa) | D638 | | | | | | | |
| Tensile modulus | | 2.5 | 2.1 | 2.2 | 3.5 | 3.4 | 2.4 | 2.3 |
| (Gpa) | | | | | | | | |
| Elongation at | ASTM | 3.2% | 2.7% | 7.8% | 1.8% | 2.4% | 2.30% | 1.5% |
| break (%) | D638 | | | | | | | |
| Volume | ASTM | 1.8 × 10\hat{ }14 | 1.6 × 10\hat{ }14 | 1.9 × 10\hat{ }14 | 1.78 × 10\hat{ }13 | 1.65 × 10\hat{ }14 | 1.85 × 10\hat{ }13 | 1.83 × 10\hat{ }14 |
| resistance | D257 | | | | | | | |
| (Ω · cm) | | | | | | | | |
| Dielectric | ASTM | 1 kHz: 4.2 | 1 kHz: 3.45 | 1 kHz: 3.9 | 1 kHz: 4.11 | 1 kHz: 2.96 | 1 kHz: 4.02 | 1 kHz: 3.70 |
| constant | D150 | | | | | | | |
| Dissipation | ASTM | 1 kHz: 0.005 | 1 kHz: 0.004 | 1 kHz: 0.004 | 1 kHz: 0.005 | 1 kHz: 0.003 | 1 kHz: 0.003 | 1 kHz: 0.005 |
| factor | D150 | | | | | | | |
| Break down | ASTM | 20 | 22 | 24 | 21 | 17 | 19 | 16 |
| voltage | D149 | | | | | | | |
| (kV/mm) | | | | | | | | |
| Thermal | ASTM | 0.22 | 0.188 | 0.186 | 0.201 | 0.213 | 0.204 | 0.195 |
| conductivity W/ | 5470 | | | | | | | |
| (m · K) | | | | | | | | |
| Flammability | UL94 - V0 | V-0 pass | V-0 pass | V-0 pass | V-0 pass | V-0 pass | V-0 pass | V-0 pass |
| Moisture | ASTM | 0.21% | 0.22% | 0.26% | 0.33% | 0.24% | 0.39% | 0.23% |
| absorption test | D570 | | | | | | | |
| lap shear | SAE J1523 | 25° C.: 12.73 | 25° C.: 13.11 | 25° C.: 12.21 | 25° C.: 11.89 | 25° C.: 12.88 | 25° C.: 11.89 | 25° C.: 12.28 |
| strength, (Mpa) | | 150° C.: 12.51 | 150° C.: 12.78 | 150° C.: 11.89 | 150° C.: 10.51 | 150° C.: 12.61 | 150° C.: 8.8 | 150° C.: 11.32 |
| (SPCC-SD | | 180° C.: 12.19 | 180° C.: 12.56 | 180° C.: 10.33 | 180° C.: 8.5 | 180° C.: 12.04 | 180° C.: 7.3 | 180° C.: 10.82 |
| steel) | | 200° C.: 9.71 | 200° C.: 10.22 | 200° C.: 7.8 | 200° C.: 7.32 | 200° C.: 10.09 | 200° C.: 5.3 | 200° C.: 8.12 |
| | | 230° C.: 2.10 | 230° C.: 3.9 | 230° C.: 1.8 | 230° C.: 2.69 | 230° C.: 4.2 | 230° C.: 1.4 | 230° C.: 3.45 |

TABLE 3
Gel Time and Tg

| Experiment No. | Gel Temperature | Tg |
|---|---|---|
| 1 | 129° C. | 155° C. |
| 2 | 123° C. | 153° C. |
| 3 | 130° C. | 133° C. |
| 4 | 97° C. | 130° C. |
| 5 | 102° C. | 149° C. |
| 6 | 103° C. | 125° C. |
| 7 | 102° C. | 174° C. |

### Observations

Exp. 1 and Exp. 2, viscosity is 1.5 Pa·s to 4.4 Pa·s up to 100 days storage stability at RT condition.

Exp. 3 Viscosity increased from 5.8 pa·s to 28.66 Pa·s at day 0 to day 100, because IPN 11 (Epoxy modified Polyurethane polymer) viscosity was higher at initial time then storage condition gradual increase of viscosity.

Exp. 4 Viscosity increased drastically from initial measurement to measurement at 40 days. After 40 days material got cured and not able to run viscosity due to Imidazole LC 80 encapsulation coating thickness not enough the storage at RT with 40 days or more.

Exp. 5 Viscosity increased drastically from initial measurement to measurement at 20 days. After 20 days material got cured and not able to run viscosity, Curezol-2P4 MZ was not encapsulation type Phenyl imidazole catalyst, the imidazole reactivity higher at room temperature so storage at RT with 20 days or more.

Exp. 6 Viscosity increased drastically from initial measurement to measurement at 20 days. After 20 days material got cured and not able to run viscosity, Resicure-2 MI was not encapsulation type imidazole catalyst, viscosity increase at RT with 20 days or more.

Exp. 7 viscosity increased drastically from initial measurement to measurement at 20 days. After 20 days material got cured and not able to run viscosity, Imicure-EMI24 was not encapsulation type imidazole catalyst, storage at RT with 20 days or more.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

It will be understood, that unless specified otherwise, the term approximately, as used herein, will be defined as the value, number, and/or integer +/−10 percent.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. A storage stable, one-component, solvent-free, non-halogenated, heat curable composition which cures to form a cured product for use in encapsulation of electrical components, comprising:
an epoxy resin;
a non-halogenated flame retardant based on phosphorus containing epoxy resin;
a cyclic anhydride hardening agent;
a catalyst;
a rheology modifier;
a heat stabilizing agent; and
wherein the composition is fast gelling/curing and exhibits a high glass transition temperature, and excellent mechanical, electrical, and flame-retardant properties.

2. A cured product formed using the composition according to claim 1.

3. A cured product formed using the composition according to claim 1, wherein the curable composition cures at a temperature of at least 140° C. that results in the cured product having a glass transition temperature of at least 140° C.

4. A cured product formed using the composition according to claim 1, wherein the cured product comprises an elongation percentage of at least approximately 1.5%, a tensile strength of at least approximately 40 Mpa, and a tensile modulus of at least approximately 2.5 Gpa.

5. A cured product formed using the composition according to claim 1, wherein the cured product comprises a flexural strength of at least approximately 55 Mpa, and a flexural modulus of at least approximately 2.2 Gpa.

6. A cured product formed using the composition according to claim 1, wherein the cured product comprises a volume resistance of at least approximately 1.5×10¹⁴ Ω·cm, a dielectric constant of at least approximately 2.5, a breakdown voltage of at least approximately 15 kv/mm, and a thermal conductivity of at least approximately 0.2 W/m·K.

7. A cured product formed using the composition according to claim 1, wherein the cured product comprises a lap shear strength at least approximately 12.0 Mpa at 25° C., 150° C., and 180° C., a lap shear strength at least approximately 8.0 Mpa at 200° C., and a lap shear strength of at least approximately 2.0 Mpa at 230° C.

8. A cured product formed using the composition according to claim 1, wherein the cured product comprises a hardness at least approximately 70 durometer Shore A.

9. A cured product formed using the composition according to claim 1, wherein the cured product comprises a moisture resistance below approximately 0.3%.

10. A cured product formed using the composition according to claim 1, wherein the cured product is compliant with flammability requirements to pass UL 94 V-0 standard requirements.

11. The composition according to claim 1, wherein the epoxy resin is present from approximately 25 percent to approximately 60 percent of the total weight of the composition and comprises at least one of a bisphenol A diglycidyl ether epoxy resin, a bisphenol F epoxy resin, a cycloaliphatic epoxy resin, bis(2,3-epoxycyclopentyl) ether, 3,4-epoxycyclohexanemethyl, 3,4-epoxycyclohexanecarboxylate, epoxy novolac, and mixtures thereof.

12. The composition according to claim 1, wherein the non-halogenated phosphorus containing epoxy resin is present from approximately 5 percent to approximately 25 percent of the total weight of the composition.

13. The composition according to claim 1, wherein the cyclic anhydride hardening agent is present from approximately 35 percent to approximately 65 percent of the total weight of the composition and comprises at least one of a nadic methyl anhydride, methyl hexahydro phthalic anhydride, tetrahydro phthalic anhydride, hexahydrophthalic anhydride, nonenyl succinic anhydride, trimellitic anhydride, and mixtures thereof.

14. The composition according to claim 1, wherein the catalyst is present from approximately 0.1 percent to approximately 10 percent of the total weight of the composition and comprises at least one of a microencapsulated aromatic polyamine, a tertiary amine, an imidazole, an encapsulated modified imidazole, a 2-phenyl substituted imidazole, a 2-methyl substituted imidazole, 2-ethyl-4-methyl imidazole, and mixtures thereof.

15. The composition according to claim 1, wherein the rheology modifier is present from approximately 0.05 percent to approximately 2.0 percent of the total weight of the composition and comprises a polyamide wax based rheology modifier.

16. The composition according to claim 1, wherein the heat stabilizing agent is present from approximately 0.05 percent to approximately 2.0 percent of the total weight of the composition and comprises a sterically hindered primary phenolic antioxidant.

17. The composition according to claim 1, wherein the composition comprises a viscosity of at least 1.5 Pa·s at 25° C. for 90 days without affecting viscosity and gel time of the cured product.

18. The composition according to claim 1, wherein the composition comprises a gel time of at least 100 seconds at 150° C.

19. A storage stable, one-component, solvent-free, non-halogenated, heat curable composition which cures to form a cured product for use in encapsulation of electrical components, comprising:
a liquid bis phenol A epoxy resin;
a liquid non-halogenated flame retardant based on phosphorus containing epoxy resin;
a cyclic anhydride curing agent;
an encapsulated imidazole catalyst;
a polyamide wax based rheology modifying agent; and
a sterically hindered primary phenolic stabilizing agent.

20. The composition according to claim 19, wherein the liquid bis phenol A epoxy resin comprises a bisphenol A diglycidyl ether epoxy resin represented by the following chemical structure and derivatives thereof: 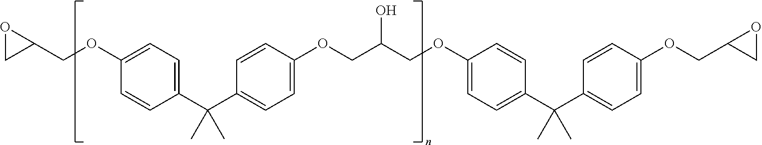
wherein n is 0 or an integer ranging from 1 to approximately 25.

21. A cured product formed using the composition according to claim 19.

22. The composition according to claim 1, wherein the composition optionally includes at least one of a brominated novolac epoxy resin, a bisphenol-A novolac epoxy resin, a bisphenol-F epoxy resin, and/or a tetra functional epoxy resin.

23. The composition according to claim 1, wherein the composition optionally includes at least one of a silane adhesion promoter and/or a surface wetting agent.

24. The composition according to claim 1, wherein the composition optionally includes at least one thermally conductive filler selected from at least one of the group of aluminum hydroxide, aluminum oxide, and/or boron nitride.
